(19) United States
(12) Patent Application Publication
(10) Pub. No.: US 2018/0001244 A1
(43) Pub. Date: Jan. 4, 2018

(54) MULTI-LAYERED ELECTRET-CONTAINING FILTRATION MEDIA

(71) Applicant: Hollingsworth & Vose Company, East Walpole, MA (US)

(72) Inventors: Siqiang Zhu, Christiansburg, VA (US); Mark A. Gallimore, Floyd, VA (US); Stephen T. Cox, Radford, VA (US)

(73) Assignee: Hollingsworth & Vose Company, East Walpole, MA (US)

(21) Appl. No.: 15/200,612

(22) Filed: Jul. 1, 2016

(51) Int. Cl. B01D 39/16; A41D 13/11; B01D 46/00; A62B 18/02; A62B 23/00

(52) U.S. Cl. CPC B01D 39/1623; A62B 18/025; A62B 23/00; B01D 46/0032; A41D 13/11; B01D 2239/065; B01D 2239/1266; B01D 2275/10; B01D 2239/0435

(57) ABSTRACT

Filter media for filtering gas streams (e.g., air) are described herein. In some embodiments, the filter media may be designed to have desirable properties such as stable filtration efficiency, high oil repellency, low instantaneous resistance, and/or stable service life. One or more layers of the media may have a certain value of thickness over instantaneous resistance (and/or a ratio of thickness over instantaneous resistance between two layers). The filter media described herein may be particularly well-suited for applications that involve filtering gas streams (e.g., face masks, cabin air filtration, vacuum filtration, respirator equipment), though the media may also be used in other applications.

### FIELD OF INVENTION

The present embodiments relate generally to filter media and methods for filtering gas streams, and specifically, to filter media having efficiency stability and/or good performance characteristics such as low resistance.

### BACKGROUND

Filter elements can be used to remove contamination in a variety of applications. Such elements can include a filter media which may be formed of a web of fibers. The fiber web provides a porous structure that permits gas (e.g., air) to flow through the media. Contaminant particles (e.g., dust particles, soot particles) contained within the fluid may be trapped on or in the fiber web. Depending on the application, the filter media may be designed to have different performance characteristics.

Although many types of filter media for filtering particulates from air exist, improvements in the physical and/or performance characteristics of the filter media (e.g., strength, air resistance, efficiency, and high dust holding capacity) would be beneficial.

### SUMMARY OF THE INVENTION

Filter media are generally provided. The subject matter of this application involves, in some cases, interrelated products, alternative solutions to a particular problem, and/or a plurality of different uses of structures and compositions.

In one set of embodiments, a series of filter media are provided. In one embodiment, a filter media comprises a first layer comprising a plurality of fibers, wherein the first layer comprises a fluorinated species, and a second layer adjacent the first layer. The first layer has a first value of a thickness over instantaneous resistance of the first layer, the second layer has a second value of a thickness over instantaneous resistance of the second layer, and the ratio of the second value to the first value is less than or equal to 20. The filter media has an initial efficiency of greater than or equal to 95%.

In another embodiment, a filter media comprises a first layer comprising a plurality of fibers, wherein the first layer comprises a fluorinated species, and a second layer adjacent the first layer. The first layer has a value of thickness over instantaneous resistance of the first layer of greater than or equal to 2 mils/mmH₂O and less than or equal to 50 mils/mm H₂O. The second layer has a value of thickness over instantaneous resistance of the second layer of greater than or equal to 20 mils/mmH₂O and less than or equal to 150 mils/mm H₂O.

In another embodiment, a filter media comprises a first layer comprising a plurality of fibers and a second layer adjacent the first layer. The first layer has a first value of a thickness over instantaneous resistance of the first layer, the second layer has a second value of a thickness over instantaneous resistance of the second layer, and the ratio of the second value to the first value is less than or equal to 20. The filter media has an initial efficiency of greater than or equal to 95%.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic diagram showing a cross-section of a filter media according to one set of embodiments;

FIG. 2 is a schematic diagram showing a cross-section of a filter media according to one set of embodiments;

FIG. 3 is a schematic diagram showing a cross-section of a filter media according to one set of embodiments;

FIG. 4 is a schematic diagram showing a cross-section of a filter media according to one set of embodiments; and

FIG. 5 is a plot of thickness over instantaneous resistance ratio of two layers of a filter media, according to one set of embodiments.

### DETAILED DESCRIPTION

Filter media such as mult-layered electret-containing filtration media for filtering gas streams (e.g., air) are described herein. In some embodiments, the filter media may be designed to have desirable properties such as stable filtration efficiency, high oil repellency, low resistance, and/or stable service life. In certain embodiments, the filter media may be a composite of two or more types of fiber layers where each layer may be optimized to enhance its function without substantially negatively impacting the performance of another layer of the media. For example, one layer of the media may be designed to have a relatively high oil repellency, and another layer of the media may be designed to have stable filtration efficiency throughout the filter's lifetime. One or more layers of the media may have a certain value of thickness over instantaneous resistance (and/or a ratio of thickness over instantaneous resistance between two layers), as described in more detail below. The filter media described herein may be particularly well-suited for applications that involve filtering gas streams (e.g., face masks, cabin air filtration, vacuum filtration, room filtration, respirator equipment), though the media may also be used in other applications.

In some embodiments, the filter media described herein may include a first layer, optionally including a fluorinated species, and a second layer that is charged. The first layer may be positioned upstream of the second layer (e.g., in a filter element) with respect to the direction of gas/fluid flow. Advantageously, the first layer may remove at least a portion of an oil present in a gas stream being filtered such that reduced amounts of the oil penetrates into the second layer, thereby minimizing discharge of the second layer. Since the presence of charges in the second layer can improve the efficiency (e.g., initial efficiency) of the media, this configuration of layers can stabilize the filtration efficiency of the filter media throughout its lifetime. In some embodiments, the filter media described herein may advantageously have lower resistance leading to, for example, more breathability (e.g., for face mask applications) compared to certain existing filter media.

In an alternative embodiment, the second layer may be positioned upstream of the first layer (e.g., in a filter element) with respect to the direction of gas/fluid flow.

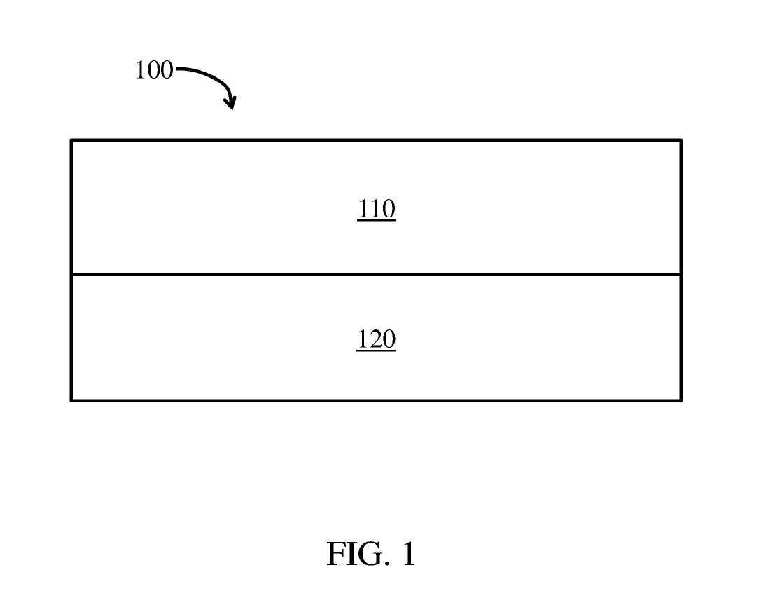

An example of a filter media including two or more layers is shown in FIG. 1. As shown illustratively in FIG. 1, a filter media 100, shown in cross section, may include a first layer 110 and a second layer 120 adjacent first layer 110. In some cases, first layer 110 may be directly adjacent (i.e., in direct contact with at least a portion of) second layer 120. In alternative embodiments, second layer 120 may be positioned upstream or downstream of, but not in contact with, first layer 110. In some embodiments, the first layer is a non-wet laid layer imparting, for example, good oleophobic properties (e.g., high oil repellency) to the filter media and the second layer may be a charged layer having, for example, high efficiency (e.g., initial efficiency) with a relatively open fibrous structure. Other configurations are also possible. For example, in some cases, the filter media includes one or more support layers (e.g., spunbond layers), as described in more detail below.

The terms “first layer” and “second layer” as used herein generally refer to different layers of a filter media and do not necessarily denote a particular order of the layers (e.g., within a filter element). For example, while in some embodiments a first layer may be positioned upstream of the second layer with respect to the direction of fluid flow, in other embodiments the first layer may be positioned downstream of the second layer with respect to the direction of fluid flow. As used herein, when a layer is referred to as being “adjacent” another layer, it can be directly adjacent to the layer, or one or more intervening layers also may be present. A layer that is “directly adjacent” another layer means that no intervening layer is present.

In some embodiments, each of the first layer and/or the second layer may include a single layer. In other embodiments, however, the first layer and/or the second layer may include more than one layer (i.e., sublayers) to form a multi-layered structure. Each sublayer within a layer may be formed by the same process as the other sublayers within the layer. For example, in one set of embodiments, a first layer includes more than one sublayers formed by a non-wet laid process such as a meltblown process, a meltspun, a melt electrospinning, a solvent electrospinning, a centrifugal spinning process, or a spunbond process. When a layer includes more than one sublayer, the plurality of sublayers may be the same or may differ based on certain features such as basis weight, efficiency (e.g., initial efficiency), and/or thickness. Generally, however, each sublayer within a given layer comprises the same type of fibers as the other sublayer(s) within the given layer. For example, a first layer may include multiple sublayers, each sublayer including fibers formed by the same process (e.g., by a meltblown process). In certain cases, the plurality of sublayers may be discrete and combined by any suitable method, such as lamination, point bonding, or collating. In some embodiments, the sublayers are substantially joined to one another (e.g., by lamination, point bonding. thermo-dot bonding, ultrasonic bonding, calendering, use of adhesives (e.g., glue-web), and/or co-pleating). In some cases, sublayers may be formed as a composite layer (e.g., by a non-wet laid process).

Each of the sublayers of the first layer and/or second layer may have any suitable basis weight and/or thickness, such as those basis weights and thicknesses described herein for the overall layer (e.g., the first layer, the second layer). Additionally, each of the sublayers of the first layer and/or second layer may have performance characteristics (e.g., resistance, efficiency) of those described herein for the overall layer.

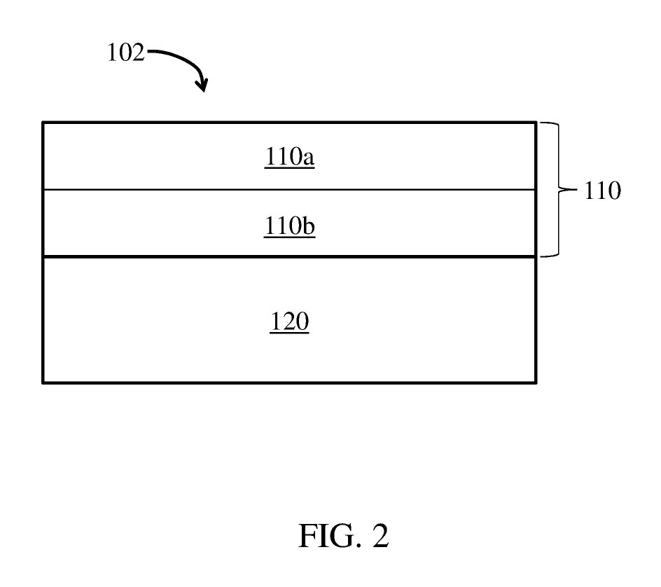

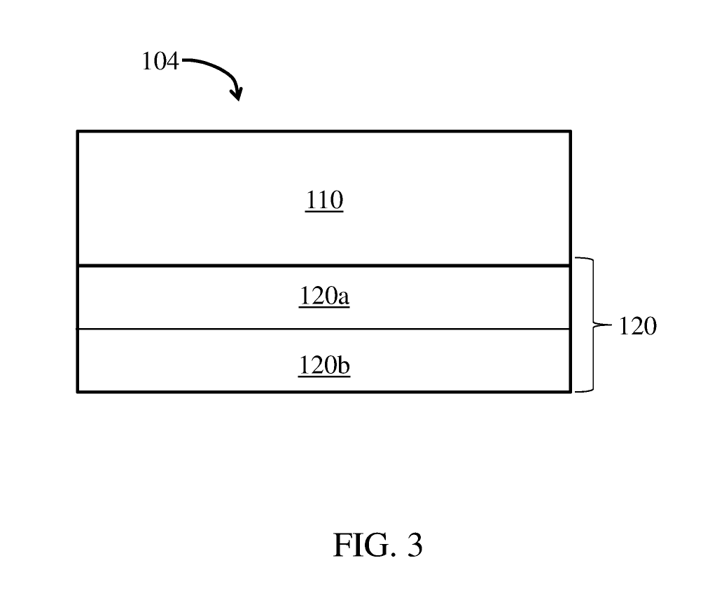

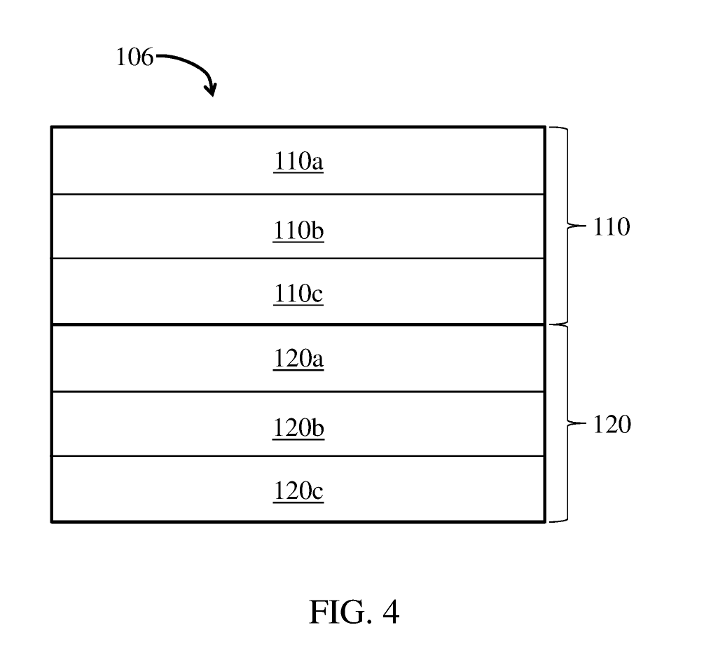

In some embodiments, a layer of the filter media may comprise two or more sublayers. In some cases, the first layer (e.g., a non-wet laid layer) may comprise two or more non-wet laid sublayers. For example, as shown illustratively in FIG. 2, filter media 102, shown in cross section, comprises a first layer 110 having a first non-wet laid sublayer 110a and a second non-wet laid sublayer 110b. The filter media also includes a second layer 120 adjacent first layer 110. In certain embodiments, the second layer (e.g., an efficiency layer and/or a charged layer) may comprise two or more sublayers. For example, as shown illustratively in FIG. 3, filter media 104 comprises first layer 110 and second layer 120 adjacent first layer 110, and having a first sublayer 120a and a second sublayer 120b. While two sublayers in each layer are shown, those skilled in the would understand that more than two sublayers (e.g., three sublayers, four sublayers, five sublayers) are also possible. In an exemplary embodiment, as shown illustratively in FIG. 4, a filter media 106 comprises first layer 110 having three non-wet laid sublayers 110a, 110b, and 110c, and second layer 120 adjacent first layer 110 having three charged sublayers 120a, 120b, and 120c. Other configurations are also possible.

The number of sublayers within the first layer and/or the second layer may be selected as desired. In some embodiments, the first layer comprises greater than or equal to 1, greater than or equal to 2, greater than or equal to 3, greater than or equal to 5, greater than or equal to 7, greater than or equal to 10, or greater than or equal to 12 sublayers (e.g., non-wet laid sublayers). In certain embodiments, the first layer comprises less than or equal to 15, less than or equal to 12, less than or equal to 10, less than or equal to 7, less than or equal to 5, less than or equal to 3, or less than or equal to 2 sublayers. Combinations of the above-referenced ranges are also possible (e.g., greater than or equal to 1 and less than or equal to 15 sublayers, greater than or equal to 1 and less than or equal to 5 sublayers, greater than or equal to 2 and less than or equal to 5 sublayers). Other ranges are also possible.

In some embodiments, the second layer comprises greater than or equal to 1, greater than or equal to 2, greater than or equal to 3, greater than or equal to 5, greater than or equal to 7, greater than or equal to 10, or greater than or equal to 12 sublayers (e.g., charged sublayers). In certain embodiments, the second layer comprises less than or equal to 15, less than or equal to 12, less than or equal to 10, less than or equal to 7, less than or equal to 5, less than or equal to 3, or less than or equal to 2 sublayers. Combinations of the above-referenced ranges are also possible (e.g., greater than or equal to 1 and less than or equal to 15 sublayers, greater than or equal to 1 and less than or equal to 5 sublayers, greater than or equal to 2 and less than or equal to 5 sublayers). Other ranges are also possible.

In some embodiments, the first layer is designed to have a particular value of thickness over instantaneous resistance of the layer (i.e., a thickness over instantaneous resistance factor). In general, it is preferable that filter media comprising a first layer have a particular value of thickness over instantaneous resistance of the first layer (e.g., greater than or equal to 2 mils/mm H₂O and less than or equal to 50 mils/mm H₂O, or another suitable range described herein) which can increase the performance of filter media (e.g., lower resistance) as compared to certain existing filter media that do not have this feature. A value of thickness over instantaneous resistance (i.e., a thickness over instantaneous resistance factor), as used herein, is the ratio of the uncompressed thickness of a layer (including all sublayers of the layer) to the instantaneous resistance of the layer (including all sublayers of the layer). Measurements of uncompressed thickness and instantaneous resistance are described in more detail below.

In certain embodiments, the first layer has a value of thickness over instantaneous resistance of the first layer of greater than or equal to 2 mils/mm H₂O, greater than or equal to 3 mils/mm H₂O, greater than or equal to 5 mils/mm H₂O, greater than or equal to 10 mils/mm H₂O, greater than or equal to 15 mils/mm H₂O, greater than or equal to 20 mils/mm H₂O, greater than or equal to 25 mils/mm H₂O, greater than or equal to 30 mils/mm H₂O, greater than or equal to 35 mils/mm H₂O, greater than or equal to 40 mils/mm H₂O, or greater than or equal to 45 mils/mm H₂O. In some embodiments, the first layer has a value of thickness over instantaneous resistance of the first layer of less than or equal to 50 mils/mm H₂O, less than or equal to 45 mils/mm H₂O, less than or equal to 40 mils/mm H₂O, less than or equal to 35 mils/mm H₂O, less than or equal to 30 mils/mm H₂O, less than or equal to 25 mils/mm H₂O, less than or equal to 20 mils/mm H₂O, less than or equal to 15 mils/mm H₂O, less than or equal to 10 mils/mm H₂O, less than or equal to 5 mils/mm H₂O, or less than or equal to 3 mils/mm H₂O. Combinations of the above-referenced ranges are also possible (e.g., greater than or equal to 2 mils/mm H₂O and less than or equal to 50 mils/mm H₂O, greater than or equal to 3 mils/mm H₂O and less than or equal to 35 mils/mm H₂O). Other ranges are also possible.

In some embodiments, the first layer (including one or more sublayers of the first layer) may be designed to have a particular uncompressed thickness (e.g., such that the thickness over instantaneous resistance factor of the first layer is greater than or equal to 2 mils/mm H₂O and less than or equal to 50 mils/mm H₂O). In some embodiments, the uncompressed thickness of the first layer may be greater than or equal to 1 mil, greater than or equal to 2 mils, greater than or equal to 5 mils, greater than or equal to 10 mils, greater than or equal to 25 mils, greater than or equal to 50 mils, greater than or equal to 100 mils, greater than or equal to 200 mils, greater than or equal to 250 mils, greater than or equal to 300 mils, or greater than or equal to 400 mils. In certain embodiments, the uncompressed thickness of the first layer (including one or more sublayers of the first layer) may be less than or equal to 500 mils, less than or equal to 400 mils, less than or equal to 300 mils, less than or equal to 250 mils, less than or equal to 200 mils, less than or equal to 100 mils, less than or equal to 50 mils, less than or equal to 25 mils, less than or equal to 10 mils, less than or equal to 5 mils, or less than or equal to 2 mils. Combinations of the above referenced ranges are also possible (e.g., greater than or equal to 1 mil and less than or equal to 500 mils, greater than or equal to 10 mils and less than or equal to 250 mils). Other ranges are also possible. Uncompressed thickness, as used herein, is determined using a Mitutoya uncompressed thickness measurement. Briefly, the fiber layer is compressed using a circular probe having a diameter of 1 mm under at least three different weights (e.g., 10 grams, 5 grams, 2 grams). The ordinary least squares linear regression is determined for each weight and corresponding thickness, and is used to calculated the thickness of the fiber layer corresponding to 0 grams of applied weight to determine the uncompressed thickness for that layer.

In some cases, the first layer may be designed to have a particular instantaneous resistance. In some embodiments, the first layer may have an instantaneous resistance of less than or equal to 40 mm H₂O, less than or equal to 35 mm H₂O, less than or equal to 30 mm H₂O, less than or equal to 25 mm H₂O, less than or equal to 20 mm H₂O, less than or equal to 15 mm H₂O, less than or equal to 10 mm H₂O, less than or equal to 5 mm H₂O, or less than or equal to 2 mm H₂O. In certain embodiments, the first layer may have an instantaneous resistance of greater than or equal to 0.1 mm H₂O, greater than or equal to 0.2 mm H₂O, greater than or equal to 0.5 mm H₂O, greater than or equal to 1 mm H₂O, greater than or equal to 2 mm H₂O, greater than or equal to 5 mm H₂O, greater than or equal to 10 mm H₂O, greater than or equal to 15 mm H₂O, greater than or equal to 20 mm H₂O, greater than or equal to 25 mm H₂O, greater than or equal to 30 mm H₂O, or greater than or equal to 35 mm H₂O. Combinations of the above referenced ranges are also possible (e.g., greater than or equal to 0.1 mm H₂O and less than or equal to 40 mm H₂O, greater than or equal to 2 mm H₂O and less than or equal to 15 mm H₂O). Other ranges are also possible. Measurements of instantaneous resistance are described below.

In certain embodiments, the first layer (or each sublayer of the first layer) has a particular instantaneous penetration. In some embodiments, the instantaneous penetration of the first layer is less than or equal to 15%, less than or equal to 10%, less than or equal to 5%, less than or equal to 3%, less than or equal to 2%, less than or equal to 1%, or less than or equal to 0.5%. In some embodiments, the instantaneous penetration of the first layer is greater than or equal to 0.01%, greater than or equal to 0.1%, greater than or equal to 0.5%, greater than or equal to 1%, greater than or equal to 2%, greater than or equal to 3%, greater than or equal to 5%, or greater than or equal to 10%. Combinations of the above-referenced ranges are also possible (e.g., less than or equal to 15% and greater than or equal to 0.01%). Other ranges are also possible. Measurements of instantaneous penetration are described below.

In some embodiments, the first layer (or each sublayer of the first layer) comprises a plurality of fibers. The fibers of the first layer (or each sublayer of the first layer) may be continuous or non-continuous. Continuous fibers and are made by a “continuous” fiber-forming process, such as a meltblown process, a meltspun, a melt electrospinning, a solvent electrospinning, a centrifugal spinning process, or a spunbond process, and typically have longer lengths than non-continuous fibers as described in more detail below. Non-continuous fibers are staple fibers that are generally cut (e.g., from a filament) or formed as non-continuous discrete fibers to have a particular length or a range of lengths as described in more detail below.

In certain embodiments, the plurality of fibers of the first layer (or each sublayer of the first layer) include synthetic fibers (synthetic polymer fibers). The synthetic fibers of the first layer (or each sublayer of the first layer) may be continuous fibers or staple fibers. Non-limiting examples of suitable synthetic fibers include polyester, polyaramid, polyimide, polyolefin (e.g., polyethylene), polypropylene, Kevlar, Nomex, halogenated polymers (e.g., polyethylene terephthalate), acrylics, polyphenylene oxide, polyphenylene sulfide, and combinations thereof. Synthetic fibers may also include multi-component fibers (i.e., fibers having multiple compositions such as bicomponent fibers).

In some embodiments, the synthetic fibers of the first layer (or in each sublayer of the first layer) are meltblown fibers, meltspun fibers, melt electrospun fibers, solvent electrospun fibers, centrifugal spun fibers, spunbond fibers, and/or combinations thereof, which may be formed of polymers described herein (e.g., polyester, polypropylene).

Synthetic fibers of the first layer (or in each sublayer of the first layer) may also include staple fibers. In some embodiments, the staple fibers may be multi-component fibers (i.e., fibers having multiple compositions such as bicomponent fibers).

In embodiments in which the first layer (or in each sublayer of the first layer) includes staple fibers, the layer may also include a binder (e.g., binder resin).

Other processes and materials used to form the first layer are also possible.

In some embodiments, the plurality of fibers (e.g., synthetic fibers, continuous fibers, staple fibers) in the first layer (or in each sublayer of the first layer) may have an average diameter of greater than or equal to 0.2 microns, greater than or equal to 0.5 microns, greater than or equal to 1 micron, greater than or equal to 2 microns, greater than or equal to 3 microns, greater than or equal to 4 microns, greater than or equal to 6 microns, greater than or equal to 8 microns, greater than or equal to 10 microns, greater than or equal to 15 microns, or greater than or equal to 20 microns. In some embodiments, the plurality of fibers in the first layer (or in each sublayer of the first layer) may have an average diameter of less than or equal to 20 microns, less than or equal to 15 microns, less than or equal to 10 microns, less than or equal to 8 microns, less than or equal to 6 microns, less than or equal to 4 microns, less than or equal to 3 microns, less than or equal to 2 microns, less than or equal to 1 micron, or less than or equal to 0.5 microns. Combinations of the above-referenced ranges are also possible (e.g., greater than or equal to 0.2 micron and less than or equal to 20 microns, greater than or equal to 1 micron and less than or equal to about 10 microns). Other values of average fiber diameter for the first layer (or each sublayer of the first layer) are also possible.

In some embodiments, the first layer comprises a plurality of fibers (e.g., synthetic fibers, continuous fibers) having a continuous length. In certain embodiments, the plurality of fibers in the first layer (or in each sublayer of the first layer) may have an average length of greater than about 5 inches, greater than or equal to about 10 inches, greater than or equal to about 25 inches, greater than or equal to about 50 inches, greater than or equal to about 100 inches, greater than or equal to about 300 inches, greater than or equal to about 500 inches, greater than or equal to about 700 inches, or greater than or equal to about 900 inches. In some instances, the fibers may have an average length of less than or equal to about 1000 inches, less than or equal to about 800 inches, less than or equal to about 600 inches, less than or equal to about 400 inches, or less than or equal to about 100 inches. Combinations of the above-referenced ranges are also possible (e.g., greater than or equal to about 50 inches and less than or equal to about 1000 inches). Other ranges are also possible.

In other embodiments, the first layer comprises a plurality of fibers (e.g., synthetic fibers, staple fibers) having an average length of less than about 5 inches (127 mm). For example, the plurality of fibers in the first layer (or in each sublayer of the first layer) may have an average length of, for example, less than or equal to about 100 mm, less than or equal to about 80 mm, less than or equal to about 60 mm, less than or equal to about 40 mm, less than or equal to about 20 mm, less than or equal to about 10 mm, less than or equal to about 5 mm, less than or equal to about 1 mm, less than or equal to about 0.5 mm, or less than or equal to about 0.1 mm. In some instances, plurality of fibers in the first layer (or in each sublayer of the first layer) may have an average length of greater than or equal to about 0.02 mm, greater than or equal to about 0.1 mm, greater than or equal to about 0.5 mm, greater than or equal to about 1 mm, greater than or equal to about 5 mm, greater than or equal to about 10 mm, greater than or equal to about 20 mm, greater than or equal to about 40 mm, greater than or equal to about 60 mm. Combinations of the above-referenced ranges are possible (e.g., greater than or equal to about 0.02 mm and less than or equal to about 80 mm, greater than or equal to about 0.03 mm and less than or equal to about 40 mm). Other ranges are also possible.

The first layer, as described herein, may have certain structural characteristics, such as basis weight and/or solidity. For instance, in some embodiments, the first layer (or each of the sub-layers of the first layer) may have a basis weight of greater than or equal to 0.1 g/m², greater than or equal to 0.5 g/m², greater than or equal to 1 g/m², greater than or equal to 3 g/m², greater than or equal to 10 g/m², greater than or equal to 25 g/m², greater than or equal to 30 g/m², greater than or equal to 40 g/m², greater than or equal to 50 g/m², greater than or equal to 60 g/m², greater than or equal to 70 g/m², greater than or equal to 80 g/m², greater than or equal to 100 g/m², greater than or equal to 200 g/m², greater than or equal to 300 g/m², or greater than or equal to 400 g/m². In some instances, the first layer (or each of the sub-layers of the first layer) may have a basis weight of less than or equal to 500 g/m², less than or equal to 400 g/m², less than or equal to 300 g/m², less than or equal to 200 g/m², less than or equal to 100 g/m², less than or equal to 90 g/m², less than or equal to 80 g/m², less than or equal to 70 g/m², less than or equal to 60 g/m², less than or equal to 50 g/m², less than or equal to 40 g/m², less than or equal to 30 g/m², less than or equal to 25 g/m², less than or equal to 10 g/m², less than or equal to 3 g/m², less than or equal to 1 g/m², or less than or equal to 0.5 g/m². Combinations of the above-referenced ranges are also possible (e.g., a basis weight of greater than or equal to 0.1 g/m² and less than or equal to 500 g/m², a basis weight of greater than or equal to 10 g/m² and less than or equal to 250 g/m², a basis weight of greater than or equal to 6 g/m² and less than or equal to 80 g/m²). Other values of basis weight are also possible. The basis weight may be determined according to the standard ISO 536.

In some embodiments, the first layer (or each of the sub-layers of the first layer) may have a solidity of greater than or equal to 0.1%, greater than or equal to 0.5%, greater than or equal to 1%, greater than or equal to 5%, greater than or equal to 10%, greater than or equal to 20%, or greater than or equal to 40%. In certain embodiments, the first layer (or each of the sub-layers of the first layer) may have a solidity of less than or equal to 50%, less than or equal to 40%, less than or equal to 30%, less than or equal to 20%, less than or equal to 10%, less than or equal to 5%, less than or equal tol%, or less than or equal to 0.5%. Combinations of the above-referenced ranges are also possible (e.g., a solidity of greater than or equal to 0.1% and less than or equal to 50%, greater than or equal to 1% and less than or equal to 20%). Other ranges are also possible. Solidity generally refers to the percentage of volume of solids with respect to the total volume of the layer.

In some embodiments, the first layer (or one or more sublayers of the first layer) comprises a fluorinated species. In some embodiments, each sublayer of the first layer comprises a fluorinated species. The fluorinated species may impart a certain level of oil repellency to the media. Non-limiting examples of fluorinated species include fluorocarbons such as those having the formula —CₙF₂ₙ₊₁ or —CₙFₘ, where n is an integer greater than 1, and m is an integer greater than 1. In some embodiments, n is less than or equal to 8, less than or equal 6, less than or equal 5, or less than or equal to 4. In some embodiments, m is less than or equal to 14, less than or equal to 13, less than or equal to 12, less than or equal to 8, less than or equal 6, less than or equal 5, or less than or equal to 4. Specific examples of fluorocarbons include CF₄, C₂F₄, C₃F₆, C₃F₈, C₄F₈, C₅F₁₂, C₆F₆, C₆F₁₂, and C₆F₁₃.

In other embodiments, fluorinated species include fluorocarbons such as those having the formula CₙFₘ—(CₓH_{y})—-Z, where n is an integer equal or greater than 1, m is an integer equal or greater than 1, x is an integer greater than 0, y is an integer greater than 0, and Z is an end functional group that can be selected from the group consisting of acrylate, methacrylate, alcohol, aldehyde, carboxylic acid, olefins, silane, bromide, iodide, thiol, amine, phenol, isocyanate, sulfonate, epoxide, and ether. In some embodiments, n is less than or equal to 11, less than or equal to 8, less than or equal 6, less than or equal 5, or less than or equal to 4. In some embodiments, m is less than or equal to 14, less than or equal to 13, less than or equal to 12, less than or equal to 8, less than or equal 6, less than or equal 5, or less than or equal to 4. In some embodiments, x is less than or equal to 12, less than or equal to 8, less than or equal 6, less than or equal 5, or less than or equal to 4. In some embodiments, y is less than or equal to 25, less than or equal to 20, less than or equal to 15, less than or equal to 10, less than or equal to 8, less than or equal 6, less than or equal 5, or less than or equal to 4. The value of m may vary depending on the value of n, and the value of y may depend on the value of x. In some cases, —(CₓH_{y})— is a linear alkane or a branched alkane.

In some embodiments, one or more fluorinated species are present in the first layer (e.g., as a coating) in an amount of greater than or equal to 0.01%, greater than or equal to 0.05%, greater than or equal to 0.1%, greater than or equal to 0.5%, greater than or equal to 0.75%, greater than or equal to 1%, greater than or equal to 2%, greater than or equal to 3%, or greater than or equal to 5% by weight of the total dry weight of the first layer. In certain embodiments, one or more fluorinated species are present in the first layer (e.g., as a coating) in an amount of less than or equal to 10%, less than or equal to 5%, less than or equal to 3%, less than or equal to 2%, less than or equal to 1%, less than or equal to 0.75%, less than or equal to 0.5%, less than or equal to 0.1%, or less than or equal to 0.05% by weight of the total dry weight of the first layer. Combinations of the above referenced ranges are also possible (e.g., greater than or equal to 0.01% and less than or equal to 10%, greater than or equal to 0.01% and less than or equal to 5%, greater than or equal to 0.05% and less than or equal to 3%, greater than or equal to 0.1% and less than or equal to 2%, greater than or equal to 0.2% and less than or equal to 0.75%). Other ranges are also possible.

The first layer, or one or more sublayers of the first layer, may be modified to comprise a fluorinated species using any suitable method. In some embodiments, the entire layer may be modified (e.g., through its thickness). For example, the interior and the surfaces of the layer (or one or more sublayers of the layer) may be modified with a fluorinated species. In certain embodiments, the interior of the layer (or one or more sublayers of the layer) may be modified without one or more outer surfaces of the layer (or one or more sublayers of the layer) being modified.

In general, any suitable method for modifying the surface and/or the interior of a layer (or one or more sublayers of the layer) may be used. In some embodiments, a coating method is used to coat a layer with a fluorinated species. For example, filter media may undergo a coating process (e.g., chemical vapor deposition), such that one or more outer surfaces of an interior layer and/or bottom layer is not coated, while the porous interior of the layer is coated. In some embodiments, the surface and/or interior of a layer (or one or more sublayers of the layer) may be modified by coating at least a portion of the surface and/or interior. In certain embodiments, a coating process involves introducing resin or a material (e.g., a fluorinated species) dispersed in a solvent or solvent mixture into a pre-formed fiber layer (e.g., a pre-formed fiber layer formed by a meltblown process, etc.).

Non-limiting examples of coating methods include the use of vapor deposition (e.g., chemical vapor, physical vapor deposition), layer-by-layer deposition, wax-solidification, self-assembly, sol-gel processing, a slot die coater, gravure coating, screen coating, size press coating (e.g., a two roll-type or a metering blade type size press coater), film press coating, blade coating, roll-blade coating, air knife coating, roll coating, foam application, reverse roll coating, bar coating, curtain coating, champlex coating, brush coating, Bill-blade coating, short dwell-blade coating, lip coating, gate roll coating, gate roll size press coating, laboratory size press coating, melt coating, dip coating, knife roll coating, spin coating, spray coating (e.g., electrospraying), gapped roll coating, roll transfer coating, padding saturant coating, and saturation impregnation.

In one set of embodiments, the first layer described herein may be modified using chemical vapor deposition (e.g., chemical vapor deposition of a fluorinated species). In chemical vapor deposition, the fiber layer is exposed to gaseous reactants from gas or liquid vapor that are deposited onto the fiber layer under high energy level excitation such as thermal, microwave, UV, electron beam or plasma. Optionally, a carrier gas such as oxygen, helium, argon and/or nitrogen may be used.

Other vapor deposition methods include atmospheric pressure chemical vapor deposition (APCVD), low pressure chemical vapor deposition (LPCVD), metal-organic chemical vapor deposition (MOCVD), plasma assisted chemical vapor deposition (PACVD) or plasma enhanced chemical vapor deposition (PECVD), laser chemical vapor deposition (LCVD), photochemical vapor deposition (PCVD), chemical vapor infiltration (CVI) and chemical beam epitaxy (CBE).

In physical vapor deposition (PVD) thin films are deposited by the condensation of a vaporized form of the desired film material onto substrate. This method involves physical processes such as high-temperature vacuum evaporation with subsequent condensation, or plasma sputter bombardment rather than a chemical reaction.

After applying the coating to the first layer, the coating may be dried or cured by any suitable method. Non-limiting examples of drying or curing methods include the use of a photo dryer, infrared dryer, ultraviolet source, electron beam, hot air oven steam-heated cylinder, or any suitable type of dryer familiar to those of ordinary skill in the art.

It should be appreciated that in some embodiments, the first layer (and any sublayers) does not include a fluorinated species.

As described herein, a filter media may include a second layer with optional sublayers. In some embodiments, the second layer is an efficiency layer (i.e., it increases the efficiency/initial efficiency of the overall media). As described in more detail below, in some embodiments the second layer is a charged layer (an electret layer).

In some embodiments, the second layer is designed to have a particular thickness over instantaneous resistance factor. In general, it is preferable that filter media comprising a second layer have a particular value of thickness over instantaneous resistance of the second layer (e.g., greater than or equal to 20 mils/mm H₂O and less than or equal to 150 mils/mm H₂O, or another suitable range as described herein), which can increase the performance of filter media (e.g., lower resistance) as compared to certain existing filter media that do not have this feature.

In certain embodiments, the second layer has a value of thickness over instantaneous resistance of the second layer (i.e., a thickness over instantaneous resistance factor) of greater than or equal to 20 mils/mm H₂O, greater than or equal to 30 mils/mm H₂O, greater than or equal to 40 mils/mm H₂O, greater than or equal to 50 mils/mm H₂O mils/mm H₂O, greater than or equal to 75 mils/mm H₂O, greater than or equal to 100 mils/mm H₂O, or greater than or equal to 125 mils/mm H₂O. In some embodiments, the second layer has a thickness over instantaneous resistance factor of less than or equal to 150 mils/mm H₂O, less than or equal to 125 mils/mm H₂O, less than or equal to 100 mils/mm H₂O, less than or equal to 75 mils/mm H₂O, less than or equal to 50 mils/mm H₂O, less than or equal to 40 mils/mm H₂O, or less than or equal to 30 mils/mm H₂O. Combinations of the above-referenced ranges are also possible (e.g., greater than or equal to 20 mils/mm H₂O and less than or equal to 150 mils/mm H₂O, greater than or equal to 40 mils/mm H₂O and less than or equal to 125 mils/mm H₂O). Other ranges are also possible.

In some embodiments, the second layer may be designed to have a particular uncompressed thickness (e.g., such that the thickness over instantaneous resistance factor of the second layer is greater than or equal to 20 mils/mm H₂O and less than or equal to 150 mils/mm H₂O). In some embodiments, the uncompressed thickness of the second layer may be greater than or equal to 5 mils, greater than or equal to 10 mils, greater than or equal to 25 mils, greater than or equal to 30 mils, greater than or equal to 50 mils, greater than or equal to 100 mils, greater than or equal to 200 mils, greater than or equal to 250 mils, greater than or equal to 300 mils, greater than or equal to 350 mils, greater than or equal to 400 mils, or greater than or equal to 500 mils. In certain embodiments, the uncompressed thickness of the second layer may be less than or equal to 600 mils, less than or equal to 500 mils, less than or equal to 400 mils, less than or equal to 350 mils, less than or equal to 300 mils, less than or equal to 250 mils, less than or equal to 200 mils, less than or equal to 100 mils, less than or equal to 50 mils, less than or equal to 30 mils, less than or equal to 25 mils, or less than or equal to 10 mils. Combinations of the above referenced ranges are also possible (e.g., greater than or equal to 5 mils and less than or equal to 600 mils, greater than or equal to 30 mils and less than or equal to 350 mils). Other ranges are also possible.

In some cases, the second layer may be designed to have a particular instantaneous resistance. In certain embodiments, the second layer may have an instantaneous resistance of greater than or equal to 0.1 mm H₂O, greater than or equal to 0.2 mm H₂O, greater than or equal to 0.5 mm H₂O, greater than or equal to 1 mm H₂O, greater than or equal to 2 mm H₂O, or greater than or equal to 5 mm H₂O. In some embodiments, the second layer may have an instantaneous resistance of less than or equal to 10 mm H₂O, less than or equal to 5 mm H₂O, or less than or equal to 2 mm H₂O. Combinations of the above referenced ranges are also possible (e.g., greater than or equal to 0.1 mm H₂O and less than or equal to 20 mm H₂O, greater than or equal to 1 mm H₂O and less than or equal to 4 mm H₂O). Other ranges are also possible. Measurements of instantaneous resistance are described below.

In certain embodiments, the second layer (or each sublayer of the second layer) as a particular instantaneous penetration. In some embodiments, the instantaneous penetration of the second layer is less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 5%, less than or equal to 3%, less than or equal to 2%, less than or equal to 1%, or less than or equal to 0.5%. In some embodiments, the instantaneous penetration of the second layer is greater than or equal to 0.01%, greater than or equal to 0.1%, greater than or equal to 0.5%, greater than or equal to 1%, greater than or equal to 2%, greater than or equal to 3%, greater than or equal to 5%, greater than or equal to 10%, greater than or equal to 20%, greater than or equal to 30%, or greater than or equal to 40%. Combinations of the above-referenced ranges are also possible (e.g., less than or equal to 15% and greater than or equal to 0.01%, less than or equal to 50% and greater than or equal to 0.01%). Other ranges are also possible. Measurements of instantaneous penetration are described below.

In some embodiments, the second layer (or each sublayer of the second layer) comprises a plurality of fibers. The fibers of the second layer (or each sublayer of the second layer) may be non-continuous (e.g., staple fibers) or continuous, and may be optionally charged.

In certain embodiments, the plurality of fibers of the second layer (or each sublayer of the second layer) include synthetic fibers (synthetic polymer fibers). The synthetic fibers of the second layer (or each sublayer of the second layer) may be staple fibers or continuous fibers. Non-limiting examples of suitable synthetic fibers include polypropylene, dry-spun acrylic (e.g., produced from a dry-spinning process), polyvinyl chloride, mod-acrylic, wet spun acrylic, polytetrafluoroethylene, polypropylene, polystyrene, polysulfone, polyethersulfone, polycarbonate, nylon (e.g., nylon 6/6), polyurethane, phenolic, polyvinylidene fluoride, polyester, polyaramid, polyimide, polyolefin (e.g., polyethylene), Kevlar, Nomex, halogenated polymers (e.g., polyethylene terephthalate), polyacrylics, polyphenylene oxide, polyphenylene sulfide, and combinations thereof. In some embodiments, the synthetic fibers are halogen-free such that significant dioxins are not detectable when incinerated. For example, the fibers may be halogen-free acrylic fibers formed by dry spinning. In some embodiments, the second layer and/or the entire filter media is halogen-free such that significant dioxins are not detectable when incinerated.

In certain embodiments, the plurality of fibers in the second layer are staple fibers that are synthetic polymer fibers, and are carded. The fibers of the second layer may be charged.

In other embodiments, the plurality of fibers in the second layer include synthetic fibers (synthetic polymer fibers) formed by a continuous fiber-forming process such as a meltblown process, a meltspun, a melt electrospinning, a solvent electrospinning, a centrifugal spinning process, or a spunbond process. For example, in some embodiments, the synthetic fibers are meltblown fibers, meltspun fibers, melt electrospun fibers, solvent electrospun fibers, centrifugal spun fibers, spunbond fibers, and/or combinations thereof. Synthetic fibers may also include multi-component fibers (i.e., fibers having multiple compositions such as bicomponent fibers). In some cases, synthetic fibers may include meltblown fibers, which may be formed of polymers described herein (e.g., polyester, polypropylene). Other processes and materials used to form the second layer are also possible. The fibers of the second layer may be charged. In some embodiments, the second layer comprises a mixture of two or more polymeric fibers. For instance, the second layer may comprise at least a first plurality of fibers comprising a first polymer and a second plurality of fibers comprising a second polymer. In certain embodiments, the first polymer and the second polymer are selected such that the first polymer and the second polymer have different dielectric constants. The two polymers having different dielectric constants may facilitate charging of the layer (e.g., triboelectric charging). Without wishing to be bound by theory, two polymers with different dielectric constants in the layer may come into frictional contact during manufacture of the layer such that one polymer will lose electrons and give them away to the other polymer and, as a result, the polymer losing electrons is net positively charged, the other polymer receiving electrons is net negatively charged. In embodiments in which the second layer of the filter media is a charged layer, the charged layer may have one or more characteristics described in commonly-owned U.S. Pat. No. 6,623,548, entitled “Filter materials and methods for the production thereof”, issued Sep. 23, 2003, which is incorporated herein by reference in its entirety for all purposes. For example, in some embodiments, the second layer is an electrostatically charged layer formed by blending together polypropylene fibers with halogen free acrylic fibers, polypropylene with polyvinyl chloride (PVC) fibers, or a mixture of halogen free acrylic fibers and PVC fibers and, optionally, carding the blended fibers so as to form a non-woven fabric.

In some embodiments, the difference in dielectric constants between the first polymer and the second polymer may be selected to be greater than or equal to 0.8, greater than or equal to 1, greater than or equal to 1.2, greater than or equal to 1.5, greater than or equal to 2, greater than or equal to 3, greater than or equal to 5, or greater than or equal to 7. In certain embodiments, the difference in dielectric constants between the first polymer and the second polymer may be selected to be less than or equal to 8, less than or equal to 7, less than or equal to 5, less than or equal to 3, less than or equal to 2, less than or equal to 1.5, less than or equal to 1.2, or less than or equal to 1. Combinations of the above-referenced ranges are also possible (e.g., greater than or equal to 0.8 and less than or equal to 8, greater than or equal to 1.5 and less than or equal to 5). Other ranges are also possible.

Table 1 shows dielectric constants for several exemplary polymers.

TABLE 1

| Materials | Dielectric constant |
|---|---|
| Polytetrafluoroethylene | 2.10 |
| Polypropylene | 2.2-2.36 |
| Polyethylene | 2.25-2.35 |
| Polystyrene | 2.45-2.65 |
| Polyvinyl chloride | 2.8-3.1 |
| Polysulfone | 3.07 |
| Polyethersulfone | 3.10 |
| Polyethylene terephthalate | 3.1 |
| Polycarbonate | 3.17 |
| Acrylic | 3.5-4.5 |
| Paper | 3.85 |
| Nylon 6/6 | 4.0-4.6 |
| Polyurethane | 6.3 |
| Phenolic | 6.5 |
| Polyvinylidene fluoride | 8.4 |

The first polymer and the second polymer may be present in the second layer (or in each of the sublayers of the second layer) in any suitable amount. For example, in some embodiments, the first polymer is present in the second layer (or in each of the sublayers of the second layer) in an amount of greater than or equal to 25 wt %, greater than or equal to 30 wt %, greater than or equal to 35 wt %, greater than or equal to 40 wt %, greater than or equal to 50 wt %, greater than or equal to 60 wt %, greater than or equal to 65 wt %, or greater than or equal to 70 wt % with respect to the total amount of fibers in the layer and/or the total weight of the layer. In certain embodiments, the first polymer is present in the second layer in an amount of less than or equal to 75 wt %, less than or equal to 70 wt %, less than or equal to 65 wt %, less than or equal to 60 wt %, less than or equal to 50 wt %, less than or equal to 40 wt %, less than or equal to 35 wt %, or less than or equal to 30 wt % with respect to the total amount of fibers in the layer and/or the total weight of the layer. Combinations of the above referenced ranges are also possible (e.g., greater than or equal to 25 wt % and less than or equal to 75 wt %). Other ranges are also possible.

In some embodiments, the second polymer is present in the second layer (or in each of the sublayers of the second layer) in an amount of less than or equal to 75 wt %, less than or equal to 70 wt %, less than or equal to 65 wt %, less than or equal to 60 wt %, less than or equal to 50 wt %, less than or equal to 40 wt %, less than or equal to 35 wt %, or less than or equal to 30 wt % with respect to the total amount of fibers in the layer and/or the total weight of the layer. In certain embodiments, the second polymer is present in the second layer in an amount of greater than or equal to 25 wt %, greater than or equal to 30 wt %, greater than or equal to 35 wt %, greater than or equal to 40 wt %, greater than or equal to 50 wt %, greater than or equal to 60 wt %, greater than or equal to 65 wt %, or greater than or equal to 70 wt % with respect to the total amount of fibers in the layer and/or the total weight of the layer. Combinations of the above referenced ranges are also possible (e.g., greater than or equal to 25 wt % and less than or equal to 75 wt %). Other ranges are also possible.

In some embodiments, the second layer comprises the first polymer in an amount of greater than or equal to about 25 wt % and less than or equal to 75 wt % and the second polymer in an amount of less than or equal to 75 wt % and greater than or equal to about 25 wt % with respect to the total amount of fibers in the layer. For example, the second layer may comprise the first polymer in an amount of greater than or equal to about 45 wt % and less than or equal to 55 wt %, and the second polymer in an amount of less than or equal to 55 wt % and greater than or equal to about 45 wt %, with respect to the total amount of fibers in the layer. In certain embodiments, the second layer comprises each of the first polymer and the second polymer in an amount of about 50 wt % with respect to the total amount of fibers in the layer.

In some embodiments, the second layer comprises a plurality of fibers (e.g., synthetic fibers, staple fibers) having an average length of less than about 5 inches (127 mm). For example, the plurality of fibers in the second layer (or in each sublayer of the second layer) may have an average length of, for example, less than or equal to about 100 mm, less than or equal to about 80 mm, less than or equal to about 60 mm, less than or equal to about 40 mm, less than or equal to about 20 mm, less than or equal to about 10 mm, less than or equal to about 5 mm, less than or equal to about 1 mm, less than or equal to about 0.5 mm, or less than or equal to about 0.1 mm. In some instances, plurality of fibers in the second layer (or in each sublayer of the second layer) may have an average length of greater than or equal to about 0.02 mm, greater than or equal to about 0.1 mm, greater than or equal to about 0.5 mm, greater than or equal to about 1 mm, greater than or equal to about 5 mm, greater than or equal to about 10 mm, greater than or equal to about 20 mm, greater than or equal to about 40 mm, greater than or equal to about 60 mm. Combinations of the above-referenced ranges are possible (e.g., greater than or equal to about 1 mm and less than or equal to about 80 mm, greater than or equal to about 1 mm and less than or equal to about 60 mm). Other ranges are also possible.

In other embodiments, the second layer comprises a plurality of fibers (e.g., synthetic fibers, continuous fibers) having a continuous length. In certain embodiments, the plurality of fibers in the second layer (or in each sublayer of the second layer) may have an average length of greater than about 5 inches, greater than or equal to about 10 inches, greater than or equal to about 25 inches, greater than or equal to about 50 inches, greater than or equal to about 100 inches, greater than or equal to about 300 inches, greater than or equal to about 500 inches, greater than or equal to about 700 inches, or greater than or equal to about 900 inches. In some instances, the fibers may have an average length of less than or equal to about 1000 inches, less than or equal to about 800 inches, less than or equal to about 600 inches, less than or equal to about 400 inches, or less than or equal to about 100 inches. Combinations of the above-referenced ranges are also possible (e.g., greater than or equal to about 50 inches and less than or equal to about 1000 inches).

The second layer, as described herein, may have certain structural characteristics, such as basis weight and/or solidity. For instance, in some embodiments, the second layer (or each of the sub-layers of the second layer) may have a basis weight of greater than or equal to 20 g/m², greater than or equal to 25 g/m², greater than or equal to 30 g/m², greater than or equal to 40 g/m², greater than or equal to 50 g/m², greater than or equal to 60 g/m², greater than or equal to 70 g/m², greater than or equal to 80 g/m², greater than or equal to 100 g/m², greater than or equal to 200 g/m², greater than or equal to 300 g/m², greater than or equal to 400 g/m², or greater than or equal to 500 g/m². In some instances, the second layer (or each of the sub-layers of the second layer) may have a basis weight of less than or equal to 600 g/m², less than or equal to 500 g/m², less than or equal to 400 g/m², less than or equal to 300 g/m², less than or equal to 200 g/m², less than or equal to 100 g/m², less than or equal to 90 g/m², less than or equal to 80 g/m², less than or equal to 70 g/m², less than or equal to 60 g/m², less than or equal to 50 g/m², less than or equal to 40 g/m², or less than or equal to 30 g/m². Combinations of the above-referenced ranges are also possible (e.g., a basis weight of greater than or equal to 20 g/m² and less than or equal to 600 g/m², a basis weight of greater than or equal to 50 g/m² and less than or equal to 300 g/m², a basis weight of greater than or equal to 50 g/m² and less than or equal to 200 g/m²). Other values of basis weight are also possible. The basis weight may be determined as described above.

In some embodiments, the second layer (or each of the sub-layers of the second layer) may have a solidity of greater than or equal to 0.1%, greater than or equal to 0.5%, greater than or equal to 1.0%, greater than or equal to 5.0%, greater than or equal to 10%, greater than or equal to 20%, or greater than or equal to 40%. In certain embodiments, the second layer (or each of the sub-layers of the second layer) may have a solidity of less than or equal to 50%, less than or equal to 40%, less than or equal to 20%, less than or equal to 10%, less than or equal to 5%, less than or equal to1%, or less than or equal to 0.5%. Combinations of the above-referenced ranges are also possible (e.g., a solidity of greater than or equal to 0.1% and less than or equal to 50%, greater than or equal to 1% and less than or equal to 20%). Other ranges are also possible.

As described herein, in some embodiments, the filter media may be a multi-layered electret-containing media. For instance, a layer (e.g., a second layer) of the media may be charged. In general, the net charge of the layer (e.g., second layer) may be negative or positive. In some instances, at least a surface of the second layer may comprise a negatively charged material and/or a positively charged material.

In some embodiments, the polymers in the second layer (e.g., the first polymer and the second polymer) may be selected based on their dielectric constant and/or position on the triboelectric series, as described herein. For example, in some embodiments the second layer is formed via a carding process (e.g., where the fibers are manipulated by rollers and extensions (e.g., hooks, needles)). The polymer fibers within the second layer with a significant difference in dielectric constant and/or that are relatively far apart on the triboelectric series may undergo contact electrification as a result of the carding process to produce a charged non-woven web. Charged non-woven webs may have enhanced performance properties, including an increased efficiency, compared to a similar non-woven web that is uncharged, all other factors being equal.

In other embodiments, a layer may be neutral (e.g., have no net charge).

Advantageously, the filter media described herein may have a relatively low pressure drop (i.e., resistance) and/or a relatively long lifetime as compared to certain existing filter media. Without wishing to be bound by theory, the filter media may have a decrease in resistance (e.g., initial resistance) when the media includes at least two layers, wherein the ratio of the value of thickness over instantaneous resistance of the second layer to the value of thickness over instantaneous resistance of the first layer (i.e., a TRF ratio) is less than or equal 20. In some embodiments, the media passesa P95 filter media test as described in more detail below.

In some embodiments, the filter media may have a ratio of the value of thickness over instantaneous resistance of the second layer to the value of thickness over instantaneous resistance of the first layer of less than or equal to 20, less than or equal to 15, less than or equal to 10, less than or equal to 5, less than or equal to 3, less than or equal to 2, or less than or equal to 1. In certain embodiments, the filter media may have a ratio of the value of thickness over instantaneous resistance of the second layer to the value of thickness over instantaneous resistance of the first layer of greater than or equal to 0.5, greater than or equal to 1, greater than or equal to 2, greater than or equal to 3, greater than or equal to 5, greater than or equal to 10, or greater than or equal to 15. In some such embodiments, the value of the thickness over instantaneous resistance of the second layer is greater than the value of the thickness over instantaneous resistance of the first layer (e.g., such that the ratio of the value of thickness over instantaneous resistance of the second layer to the value of thickness over instantaneous resistance of the first layer is greater than 1). Combinations of the above-referenced ranges are also possible (e.g., greater than or equal to 0.5 and less than or equal to 20, greater than or equal to 1 and less than or equal to 10). Other ranges are also possible.

In some embodiments, a filter media described herein (e.g., comprising a first layer and a second layer) passes a P95 filter media test performed according to the NIOSH P-95 standard (NIOSH TEB-APR-STP-0053 (Revision 2.0)). Briefly, for a filter media to pass a P95 test, the maximum penetration during 200 mg loading of DOP should not exceed 5%, and the bandwidth of the filter media, defined as the penetration difference at 26 minutes and 30 minutes of the penetration test, should not exceed 0.1%. Maximum penetration and bandwidth are described in more detail below. For example, in some embodiments, the filter media having a TRF ratio within one or more ranges described above (e.g., a TRF ratio of less than or equal to 20) may pass a P95 test. However, in other embodiments, the filter media having a TRF ratio within one or more ranges described above (e.g., a TRF ratio of less than or equal to 20) may pass a P99 test or a P100 test as described herein.

In another embodiment, a filter media described herein (e.g., comprising a first layer and a second layer) passes a P99 filter media test performed according to the NIOSH P-99 standard (NIOSH TEB-APR-STP-0052 (Revision 2.0)). Briefly, for a filter media to pass a P99 test, the maximum penetration during 200 mg loading of DOP should not exceed 1% and the bandwidth of the filter media, defined as the penetration difference at 26 minutes and 30 minutes of the penetration test, should not exceed 0.023%.

In yet another embodiment, the filter media comprising a first layer and a second layer passes a P100 filter media test performed according to the NIOSH P-100 standard (NIOSH TEB-APR-STP-0051 (Revision 2.0)). Briefly, for a filter media to pass a P100 test, the maximum penetration during 200 mg loading of DOP should not exceed 0.03% and the bandwidth of the filter media, defined as the penetration difference at 26 minutes and 30 minutes, should not exceed 0.004%.

In some embodiments, a filter media may have a ratio of the value of thickness over instantaneous resistance of the second layer to the value of thickness over instantaneous resistance of the first layer of less than or equal to 50, less than or equal to 40, less than or equal to 30, less than or equal to 20, less than or equal to 15, less than or equal to 10, less than or equal to 5, less than or equal to 3, less than or equal to 2, or less than or equal to 1. In certain embodiments, the filter media may have a ratio of the value of thickness over instantaneous resistance of the second layer to the value of thickness over instantaneous resistance of the first layer of greater than or equal to 0.5, greater than or equal to 1, greater than or equal to 2, greater than or equal to 3, greater than or equal to 5, greater than or equal to 10, greater than or equal to 15, greater than or equal to 20, greater than or equal to 30, or greater than or equal to 40. Combinations of the above-referenced ranges are also possible (e.g., greater than or equal to 0.5 and less than or equal to 50, greater than or equal to 1 and less than or equal to 30). Other ranges are also possible.

In some embodiments, the filter media having a TRF ratio within one or more ranges described above (e.g., a TRF ratio of less than or equal to 50) may pass a P99 test or a P100 test; however, other configurations are also possible.

In one set of embodiments, a filter media comprises a first layer comprising a plurality of fibers and a second layer adjacent the first layer. The first layer comprises a fluorinated species. The first layer has a first value of a thickness over instantaneous resistance of the first layer, the second layer has a second value of a thickness over instantaneous resistance of the second layer, and the ratio of the second value to the first value is less than or equal to 20. The filter media has an initial efficiency of greater than or equal to 95%. In an exemplary embodiment, a filter media comprises a first layer (e.g., a meltblown layer) comprising a plurality of meltblown fibers and a fluorinated species (e.g., a fluorinated species having the formula —CₙF₂ₙ₊₁, —CₙFₘ, or CₙFₘ—(CₓH_{y})—Z, where n is an integer equal or greater than 1 and less than or equal to 11, m is an integer equal or greater than 1 and less than or equal to 14, x is an integer greater than 0 and less than or equal to 12, y is an integer greater than 0 and less than or equal to 25, and Z is an end functional group that can be selected from the group consisting of acrylate, methacrylate, alcohol, aldehyde, carboxylic acid, olefins, silane, bromide, iodide, thiol, amine, phenol, isocyanate, sulfonate, epoxide, and ether). The fluorinated species may be deposited onto/into the first layer by a CVD deposition process or another suitable process. The filter media also includes a second layer directly adjacent the first layer. The second layer comprises a first plurality of fibers (e.g., synthetic fibers such as dry spun acrylic fibers) and a second plurality fibers (e.g., synthetic fibers such as polypropylene fibers). In some embodiments, the second layer is a charged layer. Other materials for the first and/or second plurality of fibers may also be used (e.g., two fibers that have a certain difference in dielectric constant as described herein). For example, in some embodiments the first polymer and the second polymer have a difference in dielectric constants of at least about 0.8.

In another exemplary embodiment, a filter media comprises a first layer comprising at least three meltblown sublayers, each sublayer comprising a plurality of meltblown fibers and a fluorinated species (e.g., a fluorinated species having the formula —CₙF₂ₙ₊₁, —CₙFₘ, or CₙFₘ—(CₓH_{y})—Z, where n is an integer equal or greater than 1 and less than or equal to 11, m is an integer equal or greater than 1 and less than or equal to 14, x is an integer greater than 0 and less than or equal to 12, y is an integer greater than 0 and less than or equal to 25, and Z is an end functional group that can be selected from the group consisting of acrylate, methacrylate, alcohol, aldehyde, carboxylic acid, olefins, silane, bromide, iodide, thiol, amine, phenol, isocyanate, sulfonate, epoxide, and ether). The filter media also includes a second layer directly adjacent the first layer, the second layer comprising at least two sublayers. Each sublayer may comprise a first plurality of fibers (e.g., synthetic fibers such as dry spun acrylic fibers) and a second plurality of fibers (e.g., synthetic fibers such as polypropylene fibers). Other materials for the first and/or second plurality of fibers may also be used (e.g., two fibers that have a certain difference in dielectric constant as described herein). For example, in some embodiments the first polymer and the second polymer have a difference in dielectric constants of at least about 0.8. The second layer may be charged.

In yet another exemplary embodiment, a filter media comprises a first layer comprises at least two meltblown sublayers, each sublayer comprising a plurality of meltblown fibers and a fluorinated species (e.g., a fluorinated species having the formula —CₙF₂ₙ₊₁, —CₙFₘ, or CₙFₘ—(CₓH_{y})—Z, where n is an integer equal or greater than 1 and less than or equal to 11, m is an integer equal or greater than 1 and less than or equal to 14, x is an integer greater than 0 and less than or equal to 12, y is an integer greater than 0 and less than or equal to 25, and Z is an end functional group that can be selected from the group consisting of acrylate, methacrylate, alcohol, aldehyde, carboxylic acid, olefins, silane, bromide, iodide, thiol, amine, phenol, isocyanate, sulfonate, epoxide, and ether). The filter media also includes a second layer directly adjacent the first layer.

In some embodiments, the second layer may comprise a first plurality of fibers (e.g., synthetic fibers) and a second plurality of fibers (e.g., synthetic fibers), wherein the first and second plurality of fibers are different. In some embodiments the first polymer and the second polymer have a difference in dielectric constants of at least about 0.8. The second layer may be charged.

In some embodiments, the filter media further comprises one or more support layers (e.g., a spunbond layer) comprising a plurality of spunbond fibers. The support layer(s) may be formed of a different fiber type than fibers of the first layer and/or fibers of second layer. The support layer may be attached to the first layer to provide support for the first layer, and/or may be attached to the second layer to provide support for the second layer. In some cases, a support layer is positioned between the first layer and the second layer. Those skilled in the art would understand that such a support layer is a separate layer and is not included in the calculation of the value of thickness over instantaneous resistance for the first layer or the second layer. In some embodiments, if part of the first layer, the support layer (e.g., spunbond layer) may be coated (e.g., with a fluorinated species) as described herein. In some embodiments, if part of the second layer, the support layer (e.g., spunbond layer) may be needled to the second layer. In some cases, the support layer aids in fabrication and/or manipulation of the layer(s), but is removed from the first and/or second layer prior to incorporation of the layer(s) into a filter media and/or a filter element. However, in other embodiments the support layer(s) may be present in the final filter media and/or a filter element.

In one set of embodiments, a filter media comprises a first layer comprising a plurality of fibers and a second layer adjacent the first layer. The first layer has a first value of a thickness over instantaneous resistance of the first layer, the second layer has a second value of a thickness over instantaneous resistance of the second layer, and the ratio of the second value to the first value is less than or equal to 20. The filter media has an initial efficiency of greater than or equal to 95%.

In certain embodiments, including the filter media described above and herein, the first layer does not include a fluorinated species and is not charged. However, in other embodiments, the first layer may include a fluorinated species as described herein.

In certain embodiments, including the filter media described above and herein, the first layer has a value of thickness over instantaneous resistance of the first layer of greater than or equal to 2 mils/mmH₂O and less than or equal to 50 mils/mm H₂O (or another suitable range described herein), and the second layer has a value of thickness over instantaneous resistance of the second layer of greater than or equal to 20 mils/mmH₂O and less than or equal to 150 mils/mm H₂O (or another suitable range described herein). In some embodiments, the first layer has a first value of a thickness over instantaneous resistance of the first layer and the second layer has a second value of a thickness over instantaneous resistance of the second layer, such that the ratio of the second value to the first value is less than or equal to 20 (or another suitable range described herein).

In certain embodiments, including the filter media described above and herein, the basis weight of the first layer is greater than or equal to 0.1 g/m² and less than or equal to 500 g/m² (e.g., greater than or equal to 6 g/m² and less than or equal to 80 g/m²) and/or the basis weight of the second layer is greater than or equal to 20 g/m² and less than or equal to 600 g/m² (e.g., greater than or equal to 50 g/m² and less than or equal to 200 g/m²).

In some embodiments, including the filter media described above and herein, the first plurality of fibers comprises a first polymer and the second plurality of fibers comprises a second polymer where the first polymer and the second polymer have a difference in dielectric constants of at least about 0.8.

In some embodiments, the filter media may be designed to have a particular ratio of the solidity of the first layer to the solidity of the second layer. In certain embodiments, the ratio of the solidity of the first layer to the solidity of the second layer is greater than or equal to 0.1, greater than or equal to 0.5, greater than or equal to 1, greater than or equal to 2, greater than or equal to 5, greater than or equal to 10, or greater than or equal to 20. In some cases, the ratio of the solidity of the first layer to the solidity of the second layer may be less than or equal to 25, less than or equal to 20, less than or equal to 10, less than or equal to 5, less than or equal to 2, less than or equal to 1, or less than or equal to 0.5. Combinations of the above-referenced ranges are also possible (e.g., greater than or equal to 0.1 and less than or equal to 25, greater than or equal to 1 and less than or equal to 5). Other ranges are also possible.

In certain embodiments, the total thickness of the filter media (e.g., the filter media comprising the first layer and the second layer) may be greater than or equal to 30 mils, greater than or equal to 40 mils, greater than or equal to 50 mils, greater than or equal to 75 mils, greater than or equal to 100 mils, greater than or equal to 150 mils, greater than or equal to 200 mils, greater than or equal to 250 mils, greater than or equal to 300 mils, greater than or equal to 500 mils, or greater than or equal to 750 mils. In some embodiments, the total thickness of the filter media is less than or equal to 1000 mils, less than or equal to 750 mils, less than or equal to 500 mils, less than or equal to 300 mils, less than or equal to 250 mils, less than or equal to 200 mils, less than or equal to 150 mils, less than or equal to 100 mils, less than or equal to 75 mils, less than or equal to 50 mils, or less than or equal to 40 mils. Combinations of the above-referenced ranges are also possible (e.g., greater than or equal to 30 mils and less than or equal to 1000 mils, greater than or equal to 30 mils and less than or equal to 300 mils, greater than or equal to 50 mils and less than or equal to 200 mils). Other ranges are also possible. Total thickness, as described herein, is measured using a Federal C&R thickness gauge according to the standard ASTM D1778. Briefly, the gauge has 1 square inch area in contact with the filter media and uses a 2 ounce load to lightly compress the sample as follows: the gauge is zeroed first without the filter media, then raised to allow enough space to insert the filter media, then lowered again to rest on the filter media without impact. The total thickness is noted on the dial.

As described herein, a filter media and/or a layer (e.g., a first layer, a second layer) may be designed to have a particular resistance (e.g., instantaneous resistance, initial resistance), penetration (e.g., instantaneous penetration, initial penetration, maximum penetration, bandwidth) or efficiency (e.g., instantaneous efficiency, initial efficiency). Resistance, penetration and efficiency are measured using a 8130 CertiTest™ automated filter testing unit from TSI, Inc. equipped with a DiOctyl Phthalate (DOP) generator for DOP aerosol testing based on the NIOSH P-series standard (e.g., NIOSH TEB-APR-STP-0053 (Revision 2.0)) for DOP particles. The particle size created by the DOP particle generator is 0.3 microns (mass mean diameter). The test involves using a DOP particle concentration in an air stream of about 125 mg/m³, for a continuous 30 minute challenge to accumulate 200 mg loading at a face velocity 16.4 FPM over a 100 cm² face area of the filter media/layer. The TSI 8130 CertiTest™ can record measurements at the beginning of the test (time=0) and/or at every minute for the continuous 30 minutes. Instantaneous resistance, instantaneous penetration, and instantaneous efficiency are determined instantaneously upon beginning of the test (e.g., at time=0). Initial resistance, initial penetration, and initial efficiency are determined at 1 minute after starting the test. Maximum penetration corresponds to the maximum penetration measurement during the 30 minute test. Bandwidth is calculated by taking the percentage difference in penetration between measurements obtained at 26 minutes and 30 minutes of the test.

Advantageously, the filter media comprising a first layer and a second layer as described herein may have lower initial resistance compared to certain existing filter media. In some embodiments, the initial resistance of a filter media described herein is less than or equal to 35 mm H₂O, less than or equal to 30 mm H₂O, less than or equal to 25 mm H₂O, less than or equal to 20 mm H₂O, less than or equal to 15 mm H₂O, less than or equal to 10 mm H₂O, less than or equal to 9, less than or equal to 8 mm H₂O, less than or equal to 5 mm H₂O, less than or equal to 4 mm H₂O, or less than or equal to 2 mm H₂O. In certain embodiments, the initial resistance of the filter media is greater than or equal to 1 mm H₂O, greater than or equal to 2 mm H₂O, greater than or equal to 4 mm H₂O, greater than or equal to 5 mm H₂O, greater than or equal to 10 mm H₂O, greater than or equal to 15 mm H₂O, greater than or equal to 20 mm H₂O, greater than or equal to 25 mm H₂O, or greater than or equal to 30 mm H₂O. Combinations of the above referenced ranges are also possible (e.g., less than or equal to 35 mm H₂O and greater than or equal to 1 mm H₂O, less than or equal to 20 mm H₂O and greater than or equal to 4 mm H₂O). Other ranges are also possible. In an exemplary embodiment, the filter media (e.g., a filter media that passes a P95 test as described herein) comprising a first layer and a second layer as described herein has an initial resistance of less than 10 mm H₂O.

As described herein, the filter media and/or layer (e.g., first layer, second layer) may have a particular efficiency and/or penetration. In general, efficiency is determined as 100-% Penetration. Penetration, expressed as a percentage, is defined as Pen=(C/C₀)*100, where C is the particle concentration after passage through the filter media and C₀ is the particle concentration before passage through the filter media.

In some embodiments, the instantaneous efficiency of the filter media is greater than or equal to 90%, greater than or equal to 92%, greater than or equal to 95%, greater than or equal to 96%, greater than or equal to 97%, greater than or equal to 98%, greater than or equal to 99%, greater than or equal to 99.5%, greater than or equal to 99.8%, greater than or equal to 99.9%, or greater than or equal to 99.99%. In some embodiments, the instantaneous efficiency of the filter media is less than or equal to 100%, less than or equal to 99.99%, less than or equal to 99.9%, less than or equal to 99.8%, less than or equal to 99.5%, less than or equal to 99%, less than or equal to 98%, less than or equal to 97%, less than or equal to 96%, less than or equal to 95%, or less than or equal to 92%. Combinations of the above-referenced ranges are also possible (e.g., an instantaneous efficiency of greater than or equal to 90% and less than or equal to 100%, greater than or equal to 95% and less than or equal to 100%). Other ranges are also possible.

In some embodiments, the initial efficiency of the filter media is greater than or equal to 90%, greater than or equal to 92%, greater than or equal to 95%, greater than or equal to 96%, greater than or equal to 97%, greater than or equal to 98%, greater than or equal to 99%, greater than or equal to 99.5%, greater than or equal to 99.8%, greater than or equal to 99.9%, or greater than or equal to 99.99%. In some embodiments, the initial efficiency of the filter media is less than or equal to 100%, less than or equal to 99.99%, less than or equal to 99.9%, less than or equal to 99.8%, less than or equal to 99.5%, less than or equal to 99%, less than or equal to 98%, less than or equal to 97%, less than or equal to 96%, less than or equal to 95%, or less than or equal to 92%. Combinations of the above-referenced ranges are also possible (e.g., an initial efficiency of greater than or equal to 90% and less than or equal to 100%, greater than or equal to 95% and less than or equal to 100%). Other ranges are also possible.

The filter media described herein may be designed to have a particular range of maximum penetration. In some embodiments, the filter media described herein has a maximum penetration of less than or equal to 10%, less than or equal to 5%, less than or equal to 2%, less than or equal to 1%, less than or equal to 0.5%, or less than or equal to 0.1%. In some embodiments, the filter media has a maximum penetration of greater than or equal to 0%, greater than or equal to 0.1%, greater than or equal to 0.5%, greater than or equal to 1%, greater than or equal to 2%, or greater than or equal to 5%. Combinations of the above-referenced ranges are also possible (e.g., greater than or equal to 0% and less than or equal to 10%, greater than or equal to 0% and less than or equal to 2%).

In certain embodiments, the filter media described herein may have a bandwidth. In general, the bandwidth gives an indication of stability of a filter media's efficiency during extended usage, wherein lower values of bandwidth indicate greater stability of the filter media's efficiency compared to higher values. In some embodiments, the bandwidth of the filter media is less than or equal to 3%, less than or equal to 2%, less than or equal to 1%, less than or equal to 0.5%, less than or equal to 0.1%, less than or equal to 0.05%, less than or equal to 0.023%, less than or equal to 0.005%, or less than or equal to 0.004%. In certain embodiments, the bandwidth of the filter media is greater than or equal to 0%, greater than or equal to 0.004%, greater than or equal to 0.005%, greater than or equal to 0.023%, greater than or equal to 0.05%, greater than or equal to 0.1%, greater than or equal to 0.5%, greater than or equal to 1%, or greater than or equal to 2%. Combinations of the above-referenced ranges are also possible (e.g., less than or equal to 3% and greater than or equal to 0%, less than or equal to 0.1% and greater than or equal to 0.1%). Other ranges are also possible.

The filter media described herein (or any given layer, e.g. first layer, second layer, a sublayer of the first or second layer) may be tailored to have a particular oil repellency level. Such filter media may be used, for example, to remove or coalesce oil, lubricants, and/or cooling agents from a gas stream that passes through the filter media. In some embodiments, the oil repellency level of the filter media or layer or sublayer is between 1 and 7 (e.g., 1-4, 2-5, 3-6, 4-7). In certain embodiments, the oil repellency level of the filter media or layer or sublayer is 1, 2, 3, 4, 5, 6, or 7. Oil repellency level as described herein is determined according to AATCC TM 118 (1997) measured at 23° C. and 50% relative humidity (RH). Briefly, 5 drops of each test oil (having an average droplet diameter of about 2 mm) are placed on five different locations on the surface of the filter media or layer or sublayer. The test oil with the greatest oil surface tension that does not wet (e.g., has a contact angle greater than or equal to 90 degrees with the surface) the surface of the filter media or layer or sublayer after 30 seconds of contact with the filter media at 23° C. and 50% RH, corresponds to the oil repellency level (listed in Table 2). For example, if a test oil with a surface tension of 26.6 mN/m does not wet (i.e., has a contact angle of greater than or equal to 90 degrees with the surface) the surface of the filter media or layer or sublayer after 30 seconds, but a test oil with a surface tension of 25.4 mN/m wets the surface of the filter media or layer or sublayer within thirty seconds, the filter media or layer or sublayer has an oil repellency level of 4. By way of another example, if a test oil with a surface tension of 25.4 mN/m does not wet the surface of the filter media or layer or sublayer after 30 seconds, but a test oil with a surface tension of 23.8 mN/m wets the surface of the filter media or layer or sublayer within thirty seconds, the filter media or layer or sublayer has an oil repellency level of 5. By way of yet another example, if a test oil with a surface tension of 23.8 mN/m does not wet the surface of the filter media or layer or sublayer after 30 seconds, but a test oil with a surface tension of 21.6 mN/m wets the surface of the filter media or layer or sublayer within thirty seconds, the filter media or layer or sublayer has an oil repellency level of 6. In some embodiments, if three or more of the five drops partially wet the surface (e.g., forms a droplet, but not a well-rounded drop on the surface) in a given test, then the oil repellency level is expressed to the nearest 0.5 value determined by subtracting 0.5 from the number of the test liquid. By way of example, if a test oil with a surface tension of 25.4 mN/m does not wet the surface of the filter media or layer or sublayer after 30 seconds, but a test oil with a surface tension of 23.8 mN/m only partially wets the surface of the filter media or layer or sublayer after 30 seconds (e.g., three or more of the test droplets form droplets on the surface of the filter media or layer or sublayer that are not well-rounded droplets) within thirty seconds, the filter media or layer or sublayer has an oil repellency level of 5.5.

TABLE 2

| Oil Repellency | | Surface tension |
|---|---|---|
| Level | Test Oil | (in mN/m) |
| 1 | Kaydol (mineral oil) | 31 |
| 2 | 65/35 Kaydol/n-hexadecane | 28 |
| 3 | n-hexadecane | 27.5 |
| 4 | n-tetradecane | 26.6 |
| 5 | n-dodecane | 25.4 |
| 6 | n-decane | 23.8 |
| 7 | n-octane | 21.6 |
| 8 | n-heptane | 20.1 |

As described above, in some embodiments, a layer of the filter media (e.g., the first layer or one or more sublayers of the first layer, the second layer or one or more sublayers of the second layer) may be a non-wet laid layer formed using a non-wet laid process (e.g., an air laid process, a carding process, a meltblown process). For example, in a non-wet laid process, an air laid process or a carding process may be used. For example, in an air laid process, fibers may be mixed while air is blown onto a conveyor. In a carding process, in some embodiments, the fibers are manipulated by rollers and extensions (e.g., hooks, needles) associated with the rollers.

In some embodiments, as described herein, a layer of the filter media (e.g., the first layer or one or more of the sublayers of the first layer, the second layer or one or more of the sublayers of the second layer) may include fibers formed from a meltblown process. In embodiments in which the filter media includes a meltblown layer, the meltblown layer may have one or more characteristics described in commonly-owned U.S. Pat. No. 8,608,817, entitled “Meltblown Filter Medium”, issued on Dec. 17, 2013, which is based on U.S. patent application Ser. No. 12/266,892 filed on May 14, 2009, commonly-owned U.S. Patent Publication No. 2012/0152824, entitled “Fine Fiber Filter Media and Processes”, which is based on patent application Ser. No. 12/971,539 filed on Dec. 17, 2010, commonly-owned U.S. Patent Publication No. 2012/0152824, entitled “Fine Fiber Milter Media and Processes”, which is based on patent application Ser. No. 12/971,539 filed on Dec. 17, 2010, and commonly-owned U.S. Patent Publication No. 2012/0152821, entitled “Fine Fiber Milter Media and Processes”, which is based on patent application Ser. No. 12/971,594 filed on Dec. 17, 2010, each of which is incorporated herein by reference in its entirety for all purposes. The filter media may be used for a number of applications, such as respirator and face mask applications, cabin air filtration, military garments, HVAC systems (e.g., for industrial areas and buildings), clean rooms, vacuum filtration, room air cleaning, and respirator protection equipment (e.g., industrial respirators).

In some embodiments, the filter media may be incorporated into a face mask. The filter media can be, for example, folded, edge sealed, collated, or molded, with or without a supporting structure, within the face mask. The face mask may be a full face piece or a half face piece, and may be disposable or reusable. In general, face masks are used to protect the respiratory system when the air contains hazardous amounts of particulate contaminants in the form of solid particles or liquid droplets that can cause impairment through inhalation. Accordingly, a face mask generally needs to provide adequate protection with good breathability (e.g., low resistance). The face mask may be designed to filter dust, fog, fumes, vapors, smoke, sprays or mists. For example, face masks may be worn in areas where activities such as grinding, welding, road paving (e.g., where hot asphalt fumes are present), coal mining, transferring diesel fuel, or pesticide spraying are performed. The face mask may also be designed for wearing in hospitals (e.g., performing surgery), distillers and refineries in chemical industries, painting facilities, or oil fields. For example, the face mask may be a surgical face mask or an industrial face mask.

The filter media may be incorporated into a variety of other suitable filter elements for use in various applications including gas filtration. For example, the filter media may be used in heating and air conditioning ducts. Filter elements may have any suitable configuration as known in the art including bag filters and panel filters. Filter assemblies for filtration applications can include any of a variety of filter media and/or filter elements. The filter elements can include the above-described filter media and/or layers (e.g., first layer, second layer). Examples of filter elements include gas turbine filter elements, dust collector elements, heavy duty air filter elements, automotive air filter elements, air filter elements for large displacement gasoline engines (e.g., SUVs, pickup trucks, trucks), HVAC air filter elements, HEPA filter elements, ULPA filter elements, and vacuum bag filter elements.

Filter elements can be incorporated into corresponding filter systems (gas turbine filter systems, heavy duty air filter systems, automotive air filter systems, HVAC air filter systems, HEPA filter systems, ULPA filter system, and vacuum bag filter systems). The filter media can optionally be pleated into any of a variety of configurations (e.g., panel, cylindrical).

Filter elements can also be in any suitable form, such as radial filter elements, panel filter elements, or channel flow elements. A radial filter element can include pleated filter media that are constrained within two open wire support materials in a cylindrical shape.

In some cases, the filter element includes a housing that may be disposed around the filter media. The housing can have various configurations, with the configurations varying based on the intended application. In some embodiments, the housing may be formed of a frame that is disposed around the perimeter of the filter media. For example, the frame may be thermally sealed around the perimeter. In some cases, the frame has a generally rectangular configuration surrounding all four sides of a generally rectangular filter media. The frame may be formed from various materials, including for example, cardboard, metal, polymers, or any combination of suitable materials. The filter elements may also include a variety of other features known in the art, such as stabilizing features for stabilizing the filter media relative to the frame, spacers, or any other appropriate feature.

As noted above, in some embodiments, the filter media can be incorporated into a bag (or pocket) filter element. A bag filter element may be formed by any suitable method, e.g., by placing two filter media together (or folding a single filter media in half), and mating three sides (or two if folded) to one another such that only one side remains open, thereby forming a pocket inside the filter. In some embodiments, multiple filter pockets may be attached to a frame to form a filter element. It should be understood that the filter media and filter elements may have a variety of different constructions and the particular construction depends on the application in which the filter media and elements are used. In some cases, a substrate may be added to the filter media.

The filter elements may have the same property values as those noted above in connection with the filter media and/or layers. For example, the above-noted instantaneous resistances, efficiencies, (total) thicknesses, and/or basis weight may also be found in filter elements. During use, the filter media mechanically trap contaminant particles on the filter media as fluid (e.g., air) flows through the filter media.

Other systems, devices, and applications are also possible and those skilled in the art would be capable of selecting such systems, devices, and applications based upon the teachings of this specification.

### EXAMPLES

Samples were prepared as listed in Table 3:

TABLE 3

| Filter Media | 1st Layer with fluorinated species | 2nd Layer |
|---|---|---|
| 1 | 3 sublayers B | 2 sublayers C50 |
| 2* | 1 sublayer C + 2 sublayers D | 2 sublayers C50 |
| 3 | 2 sublayers D | 2 sublayers C100 |
| 4 | 1 sublayer D + 1 sublayer E | 2 sublayers C100 |
| 5 | 1 sublayer E | 1 sublayer C200 |
| 6 | 3 sublayers F | 2 sublayers C100 |
| 7 | 2 sublayers F | 1 sublayer C200 |

*Filter media includes fluorinated SB intervening layer between 1^{st} and 2^{nd} layers
SB = spunbond, light weight nonwoven polypropylene fiber material as structure reinforcement
B = a meltblown polypropylene fiber layer with basis weight of 20 g/m² reinforced by a SB layer
C = a fine fiber meltblown polypropylene fiber layer with basis weight of 6 g/m² reinforced by a SB layer
D = a meltblown polypropylene fiber layer with basis weight of 20 g/m²
E = a meltblown polypropylene fiber layer with basis weight of 20 g/m² reinforced by a SB layer
F = a meltblown polypropylene layer with basis weight of 80 g/m²
C50, C100, C200 = a charged layer made of polypropylene and acrylic fibers of 50, 100, 200 g/m² basis weight, respectively

Tables 4-5 summarize the various properties of the filter media listed in Table 3. Table 4 summarizes the instantaneous resistance, instantaneous penetration, basis weight, uncompressed thickness, and solidity for the first layer of each filter media listed in Table 3.

TABLE 4

| | 1^{st} layer | | | | | |
|---|---|---|---|---|---|---|
| | | | | Mitutoya | | Uncompressed |
| | | | | Un- | | thickness to |
| | Instantaneous | | Basis | compressed | | instantaneous |
| Filter | Resistance (in | Instantaneous | weight, | Thickness, | | resistance ratio of the |
| Media | mm H₂O) | Penetration | gsm | mil | Solidity | 1^{st} layer (TRF) |
| 1 | 13.2 | 2.46% | 75 | 46 | 0.082 | 3.5 |
| 2 | 13.5 | 2.17% | 76 | 48 | 0.074 | 3.5 |
| 3 | 8 | 1.28% | 40 | 24 | 0.085 | 3.1 |
| 4 | 8.3 | 1.19% | 55 | 34 | 0.081 | 4.1 |
| 5 | 4 | 11% | 35 | 22 | 0.078 | 5.5 |
| 6 | 5.7 | 1.60% | 240 | 162 | 0.071 | 28.5 |
| 7 | 4.4 | 6.38% | 160 | 108 | 0.071 | 24.6 |

Table 5 summarizes the instantaneous resistance, instantaneous penetration, basis weight, uncompressed thickness, and solidity for the second layer of each filter media listed in Table 3.

TABLE 5

| | 2^{nd} Layer | | | | | |
|---|---|---|---|---|---|---|
| | | | | Mitutoya | | Un-compressed |
| | | | | Un- | | thickness to |
| | Instantaneous | | Basis | compressed | | instantaneous |
| Filter | Resistance (in | Instantaneous | weight, | Thickness, | | resistance ratio of the |
| Media | mm H₂O) | Penetration | gsm | mil | Solidity | 2^{nd} layer (TRF) |
| 1 | 1.2 | 15.20% | 100 | 152 | 0.033 | 127 |
| 2 | 1.2 | 15.20% | 100 | 152 | 0.033 | 127 |
| 3 | 2 | 1.77% | 200 | 230 | 0.037 | 115 |
| 4 | 2 | 1.77% | 200 | 230 | 0.037 | 115 |
| 5 | 2.3 | 0.58% | 200 | 132 | 0.064 | 57 |
| 6 | 2 | 1.77% | 200 | 230 | 0.037 | 115 |
| 7 | 2.3 | 0.58% | 200 | 132 | 0.064 | 57 |

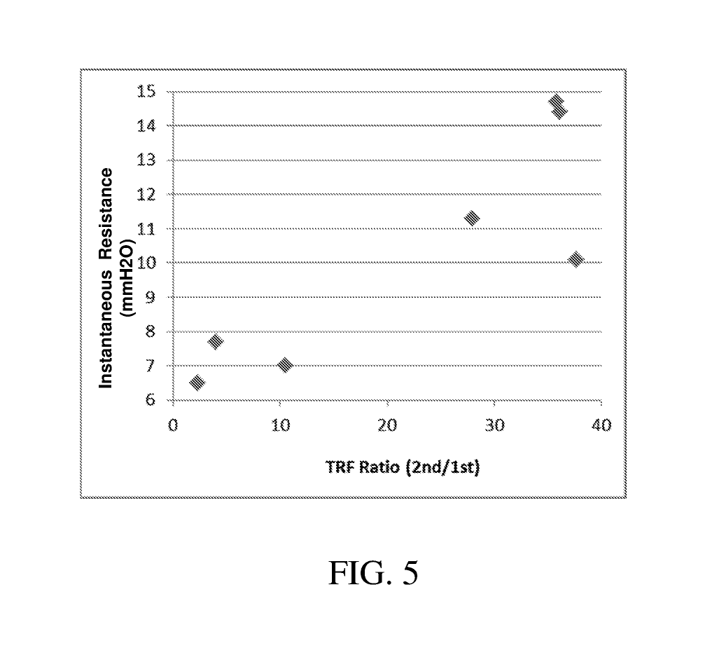

Table 6 summarizes the total thickness, initial resistance, initial penetration, and the ratio of a value of thickness over instantaneous resistance of the second layer to a value of thickness over instantaneous resistance of first layer (TRF ratio), of the filter media listed in Table 3. As shown in Table 6, which is plotted in FIG. 5, filter media samples 5-7, having a TRF ratio of less than or equal to 10 had an instantaneous resistance of less than 10 mm H₂O.

TABLE 6

| | | | | Ratio of the value of thickness |
|---|---|---|---|---|
| | Total | | | over instantaneous resistance |
| | Thick- | Initial | Initial | of second layer to the value of |
| Filter | ness, | Resistance, | pene- | thickness over instantaneous |
| Media | mil* | mm H₂O | tration | resistance of first layer |
| 1 | 136 | 14.4 | 0.37% | 36 |
| 2 | 140 | 14.7 | 0.33% | 36 |
| 3 | 189 | 10.1 | 0.05% | 38 |
| 4 | 200 | 11.3 | 0.04% | 28 |
| 5 | 142 | 7 | 0.04% | 10 |
| 6 | 290 | 7.7 | 0.31% | 4 |
| 7 | 194 | 6.5 | 0.22% | 2 |

*Measured according to the standard ASTM D1778.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in some embodiments, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in some embodiments, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The term “alkane” is given its ordinary meaning in the art and refers to a saturated hydrocarbon molecule.

The term “amine” is given its ordinary meaning in the art and refers to a primary (—NH₂), secondary (—NHRₓ), tertiary (—NRₓR_{y}), or quaternary (—N⁺RₓR_{y}R_{z}) amine (e.g., where Rₓ, R_{y}, and R_{z} are independently an aliphatic, alicyclic, alkyl, aryl, or other moieties, as defined herein).

What is claimed is:

1. A filter media, comprising:
a first layer comprising a plurality of fibers, wherein the first layer comprises a fluorinated species; and
a second layer adjacent the first layer,
wherein the first layer has a first value of a thickness over instantaneous resistance of the first layer,
wherein the second layer has a second value of a thickness over instantaneous resistance of the second layer,
wherein the ratio of the second value to the first value is less than or equal to 20, and
wherein the filter media has an initial efficiency of greater than or equal to 95%.

2. A filter media, comprising:
a first layer comprising a plurality of fibers, wherein the first layer comprises a fluorinated species; and
a second layer adjacent the first layer,
wherein the first layer has a value of thickness over instantaneous resistance of the first layer of greater than or equal to 2 mils/mmH₂O and less than or equal to 50 mils/mm H₂O, and
wherein the second layer has a value of thickness over instantaneous resistance of the second layer of greater than or equal to 20 mils/mmH₂O and less than or equal to 150 mils/mm H₂O.

3. A filter media as in claim 1, wherein the first layer comprises two or more sublayers.

4. A filter media as in claim 1, wherein the second layer comprises two or more sublayers.

5. A filter media as in claim 4, wherein at least one of the two or more sublayers of the first layer is a non-wet laid layer.

6. A filter media as in claim 1, wherein the second layer comprises a first plurality of fibers comprising a first polymer and a second plurality of fibers comprising a second polymer.

7. A filter media as in claim 1, wherein the first layer is a non-wet laid layer.

8. A filter media as in claim 1, wherein a ratio of the solidity of the first layer and the solidity of the second layer is greater than or equal to 0.1 and less than or equal to 25.

9. A filter media as in claim 1, wherein the filter media has an initial resistance of less than 10 mm H₂O.

10. A filter media as in claim 1, wherein the first layer has a basis weight of at least 0.1 g/m² and less than or equal to 500 g/m².

11. A filter media as in claim 1, wherein the second layer has a basis weight of at least 20 g/m² and less than or equal to 600 g/m².

12. A filter media as in claim 1, wherein the first polymer and the second polymer have a difference in dielectric constants of at least about 0.8.

13. A filter media as in claim 1, wherein the filter media has a bandwidth of less than or equal to 0.1%.

14. A filter media as in claim 1, wherein the first layer comprises a plurality of meltblown fibers, meltspun fibers, melt electrospun fibers, solvent electrospun fibers, centrifugal spun fibers, spunbond fibers, and/or combinations thereof.

15. A filter media as in claim 1, wherein the first polymer comprises acrylic.

16. A filter media as in claim 1, wherein the first plurality of fibers comprise dry spun acrylic fibers, mod-acrylic fibers, wet spun acrylic fibers, or combinations thereof.

17. A filter media as in claim 1, wherein the second polymer comprises polypropylene.

18. A filter media as in claim 1, wherein the first polymer comprises polypropylene and the second polymer comprises dry spun acrylic.

19. A filter media as in claim 1, wherein the filter media has a total thickness of greater than or equal to 30 mils and less than or equal to 300 mils.

20. A filter media as in claim 1, wherein the first layer has an uncompressed thickness of greater than or equal to 20 mils and less than or equal to 200 mils.

21. A filter media as in claim 1, wherein the second layer has an uncompressed thickness of greater than or equal to 100 mils and less than or equal to 250 mils.

22. A filter media as in claim 1, wherein the second layer is charged.

23. A filter element comprising the filter media as in claim 1.

24. A face mask comprising the filter media as in claim 1.

25. A filter element as in claim 23, wherein the first layer is positioned upstream relative to the second layer.
